(19) United States
(12) Patent Application Publication
(10) Pub. No.: US 2025/0103878 A1
(43) Pub. Date: Mar. 27, 2025

(54) SYSTEMS AND METHODS FOR MACHINE UNLEARNING IN GENERATIVE MODELS

(71) Applicant: JPMORGAN CHASE BANK, N.A., New York, NY (US)

(72) Inventors: Guihong LI, Austin, TX (US); Hsiang HSU, Boston, MA (US); Richard CHEN, Baldwin Place, NY (US)

(21) Appl. No.: 18/474,916

(22) Filed: Sep. 26, 2023

(51) Int. Cl. G06N 3/08; G06N 3/0455; G06N 3/0475

(52) U.S. Cl. CPC G06N 3/08; G06N 3/0455; G06N 3/0475

(57) ABSTRACT

In some aspects, the techniques described herein relate to a method including: providing a first datum to a target model, wherein the first datum is retrieved from a forget dataset; providing a sample drawn from Gaussian noise to an original model; computing a first loss, wherein the first loss is based on target model output from processing the first datum and original model output from processing the sample drawn from Gaussian noise; providing a second datum to the target model, wherein the second datum is retrieved from a retain dataset; providing the second datum to the original model as input to the original model; computing a second loss, wherein the second loss is based on target model output from processing the second datum and original model output from processing the second datum; and combining the first loss and the second loss with an alpha weighting to generate a weighted combination.

### BACKGROUND

### 1. Field of the Invention

Aspects generally relate to systems and methods for machine unlearning in generative models.

### 2. Description of the Related Art

Artificial intelligence-based (e.g., machine learning) generative models have shown great potential for content generation, having generated content that is on-par or even better than human professionals. For instance, by following human input to a prompt, large language models can generate high-quality textual responses, and given a textual description, diffusion models can draw very realistic pictures. The power of generative models, however, has raised many concerns with respect to user privacy and data governed by copyright law. Jurisdictional copyright law is ubiquitous, and it is largely yet to be seen how such law will be applied to generative models. Moreover, privacy laws and regulations are becoming more widespread and comprehensive every day. This environment can pose significant risk to organizations that provide generative models that have been trained on (i.e., learned), and may reproduce, regulated content, and retraining models from scratch with verified datasets can be an impractical solution for risk mitigation. Complicating matters further, often the original dataset that a model was trained on is unavailable. Therefore, even if the time and resources for filtering regulated or other unwanted content from the original dataset was available, it is not possible to do so. While some research has proposed different unlearning algorithms, these approaches have been focused on classification tasks only.

### SUMMARY

In some aspects, the techniques described herein relate to a method including: executing initial steps of a machine unlearning process, wherein the initial steps include: providing a first datum to a target model as input to the target model, wherein the first datum is retrieved from a forget dataset; providing a sample drawn from Gaussian noise to an original model; computing a first loss, wherein the first loss is based on target model output from processing the first datum and original model output from processing the sample drawn from Gaussian noise; providing a second datum to the target model as input to the target model, wherein the second datum is retrieved from a retain dataset; providing the second datum to the original model as input to the original model; computing a second loss, wherein the second loss is based on target model output from processing the second datum and original model output from processing the second datum; and combining the first loss and the second loss with an alpha weighting to generate a weighted combination of the first loss and the second loss.

In some aspects, the techniques described herein relate to a method, including: executing a total loss accumulation process, wherein the total loss accumulation process includes a plurality of iterations of the initial steps of the machine unlearning process.

In some aspects, the techniques described herein relate to a method, wherein the total loss accumulation process includes accumulating a total loss based on the plurality of iterations of the initial steps of the machine unlearning process.

In some aspects, the techniques described herein relate to a method, wherein the initial steps of the machine unlearning process include: updating the target model based on the total loss, wherein executing the total loss accumulation process and updating the target model based on the total loss are secondary steps of the machine unlearning process, and wherein a complete iteration of the machine unlearning process includes executing the initial steps of the machine unlearning process and the secondary steps of the machine unlearning process.

In some aspects, the techniques described herein relate to a method, including: executing a plurality of complete iterations of the machine unlearning process, wherein for each complete iteration of the plurality of complete iterations of the machine unlearning process, a new first datum is provided as input to the target model and a new second datum is provided as input to the target model and to the original model.

In some aspects, the techniques described herein relate to a method, wherein executing the plurality of complete iterations of the machine unlearning process minimizes an expectation value.

In some aspects, the techniques described herein relate to a method, wherein the plurality of complete iterations of the machine unlearning process is a fixed number of iterations.

In some aspects, the techniques described herein relate to a system including at least one computer including a processor and a memory, wherein the at least one computer is configured to: execute initial steps of a machine unlearning process, wherein the initial steps configure the at least one computer to: provide a first datum to a target model as input to the target model, wherein the first datum is retrieved from a forget dataset; provide a sample drawn from Gaussian noise to an original model; compute a first loss, wherein the first loss is based on target model output from processing the first datum and original model output from processing the sample drawn from Gaussian noise; provide a second datum to the target model as input to the target model, wherein the second datum is retrieved from a retain dataset; provide the second datum to the original model as input to the original model; compute a second loss, wherein the second loss is based on target model output from processing the second datum and original model output from processing the second datum; and combine the first loss and the second loss with an alpha weighting to generate a weighted combination of the first loss and the second loss.

In some aspects, the techniques described herein relate to a system, the at least one computer is configured to: execute a total loss accumulation process, wherein the total loss accumulation process includes a plurality of iterations of the initial steps of the machine unlearning process.

In some aspects, the techniques described herein relate to a system, wherein the total loss accumulation process includes accumulating a total loss based on the plurality of iterations of the initial steps of the machine unlearning process.

In some aspects, the techniques described herein relate to a system, wherein the initial steps of the machine unlearning process include: updating the target model based on the total loss, wherein executing the total loss accumulation process and updating the target model based on the total loss are secondary steps of the machine unlearning process, and wherein a complete iteration of the machine unlearning process includes executing the initial steps of the machine unlearning process and the secondary steps of the machine unlearning process.

In some aspects, the techniques described herein relate to a system, the at least one computer is configured to: execute a plurality of complete iterations of the machine unlearning process, wherein for each complete iteration of the plurality of complete iterations of the machine unlearning process, a new first datum is provided as input to the target model and a new second datum is provided as input to the target model and to the original model.

In some aspects, the techniques described herein relate to a system, wherein execution of the plurality of complete iterations of the machine unlearning process minimizes an expectation value.

In some aspects, the techniques described herein relate to a system, wherein the plurality of complete iterations of the machine unlearning process is a fixed number of iterations.

In some aspects, the techniques described herein relate to a non-transitory computer readable storage medium, including instructions stored thereon, which instructions, when read and executed by one or more computer processors, cause the one or more computer processors to perform steps including: executing initial steps of a machine unlearning process, wherein the initial steps include: providing a first datum to a target model as input to the target model, wherein the first datum is retrieved from a forget dataset; providing a sample drawn from Gaussian noise to an original model; computing a first loss, wherein the first loss is based on target model output from processing the first datum and original model output from processing the sample drawn from Gaussian noise; providing a second datum to the target model as input to the target model, wherein the second datum is retrieved from a retain dataset; providing the second datum to the original model as input to the original model; computing a second loss, wherein the second loss is based on target model output from processing the second datum and original model output from processing the second datum; and combining the first loss and the second loss with an alpha weighting to generate a weighted combination of the first loss and the second loss.

In some aspects, the techniques described herein relate to a non-transitory computer readable storage medium, including: executing a total loss accumulation process, wherein the total loss accumulation process includes a plurality of iterations of the initial steps of the machine unlearning process.

In some aspects, the techniques described herein relate to a non-transitory computer readable storage medium, wherein the total loss accumulation process includes accumulating a total loss based on the plurality of iterations of the initial steps of the machine unlearning process.

In some aspects, the techniques described herein relate to a non-transitory computer readable storage medium, wherein the initial steps of the machine unlearning process include: updating the target model based on the total loss, wherein executing the total loss accumulation process and updating the target model based on the total loss are secondary steps of the machine unlearning process, and wherein a complete iteration of the machine unlearning process includes executing the initial steps of the machine unlearning process and the secondary steps of the machine unlearning process.

In some aspects, the techniques described herein relate to a non-transitory computer readable storage medium, including: executing a plurality of complete iterations of the machine unlearning process, wherein for each complete iteration of the plurality of complete iterations of the machine unlearning process, a new first datum is provided as input to the target model and a new second datum is provided as input to the target model and to the original model.

In some aspects, the techniques described herein relate to a non-transitory computer readable storage medium, wherein executing the plurality of complete iterations of the machine unlearning process minimizes an expectation value.

### BRIEF DESCRIPTION OF THE DRAWINGS

FIG. 1 is a block diagram of a system for providing machine unlearning in generative models, in accordance with aspects.

FIG. 2 is a logical flow of a machine unlearning process, in accordance with aspects.

FIG. 3 is a block diagram of a technology infrastructure and computing device for implementing certain aspects of the present disclosure, in accordance with aspects.

### DETAILED DESCRIPTION

Aspects generally relate to systems and methods for machine unlearning in generative models.

Aspects described herein provide for systems and methods that allow a generative model to “forget,” or “unlearn” data in a specified dataset. Aspects may unlearn regulated, private, or other data collected in a “forget dataset” of data, while preserving model performance with respect to learned data that is not present in the forget dataset (i.e., a “retain dataset”). This procedure is referred to as “machine unlearning” herein. Aspects describe an efficient machine unlearning algorithm for encoder-decoder based image-to-image generative models.

As used herein, the term “sensitive data” refers to any data that an organization may want a machine learning model, such as a generative model, to forget or unlearn. While the term may refer to regulated data, such as personally identifiable information (PII) or data governed by copyright law, or data subject to an organization's internal data governance policy, as used herein sensitive data may be any datum or dataset that an implementing organization includes in a forget dataset or is otherwise provided as input in a machine unlearning process in order to have a ML model forget or unlearn the sensitive data.

As used herein, a datum may include a picture or an image. A datum, such as a picture or an image, may be included in a dataset of that includes additional datums.

Image-to-image generative models generally consist of two sub-models: (i) an encoder S_{θ} which encodes a randomly masked input image into a representation vector z, and (ii) a decoder G_{ϕ} that reconstructs the original image based on the representation vector (i.e., unmasking the input images). Formally, the loss function of image-to-image can be written as:

$${arg min}_{θ , ϕ} {E}_{x ∼ 𝒟} ℳ ( {G}_{ϕ} ( z ) , x ) , z = {S}_{θ} ( x ⊙ M ) ,$$

where M is a mechanism to provide partial information based on the input x; ⊙ is the Hadamard product; [symbol] is the metric used to evaluate the difference between generated images and ground truth images, e.g., l₂ loss for Masked-Auto Encoder (MAE) and KL divergence for diffusion models.

In accordance with aspects, the goal of a machine unlearning algorithm may be two-fold: (i) destroy or “forget” the unwanted information on the sample to be forgotten or unlearned (i.e., the forget dataset), and (ii) preserve the knowledge of the trained model with respect to the remaining samples (i.e., the retain dataset). Therefore, given a pretrained image-to-image generative model's encoder S*_{θ}, the following objective function may be written:

$${arg min}_{θ} {E}_{{x}_{r} , {x}_{f} , B} {‖ {S}_{θ} ( {x}_{r} ⊙ M ) - {S}_{θ}^{*} ( {x}_{r} ⊙ M ) ‖}_{{2}_{2}} + λ {‖ {S}_{θ} ( {x}_{f} ⊙ M ) - {S}_{θ}^{*} ( B ⊙ M ) ‖}_{2} , {x}_{r} ∼ {𝒟}_{R} , {x}_{f} ∼ {D}_{F} , B ∼ 𝒩 ( 0 , Σ ) .$$

In the objective function, above, M is a randomly sampled image mask, xᵣ is the sample from the retain set (D_{R}), x_{f} is the sample from the forget set (D_{F}), and B is randomly sampled standard Gaussian noise; ∥⋅∥₂ is the l₂ loss. In accordance with aspects, an optimization goal of the objective equation, above, is to make the output with respect to D_{R} close to the original model while making the output with respect to D_{F} close to the random noise.

In accordance with aspects, a machine unlearning process may include an original model and a target model, where the original model is a ML model trained on a dataset that includes, or included when the dataset was intact, sensitive data. A target model may be a copy of the original ML model that will be subjected to a machine unlearning process.

In accordance with aspects, a machine unlearning process may include two datasets, a forget dataset and a retain dataset. A forget data set may include data that will be provided as input to a machine unlearning process. A machine unlearning process may be configured to partially or fully reverse any influence that the data included in the forget dataset previously had on the target model. That is, the machine unlearning process is configured to manipulate the model so as to reverse any training of the model with respect to the forget dataset that resulted in the model learning (i.e., being configured through the training process) to generate output based on the data in the forget dataset. This may be referred to as the model “forgetting” or “unlearning” the data in the forget dataset.

Aspects may further provide data included in a retain dataset as input to the target model. Data included in a retain dataset may be data that has been filtered to remove sensitive data (e.g., data that is included in, or is similar to data included in a forget dataset). Data in a retain dataset may be data that has been verified as acceptable data with which to train a ML model from a governmental, regulatory, organizational, or other standpoint. Data in a retain dataset may or may not include some data from a dataset that was initially used to train the original model (and the target model, since the target model is a copy of the original model at the beginning of a machine unlearning process). Axiomatically, a retain dataset will not include data that is also included in a forget dataset and that will be used correspondingly with the retain dataset in a machine unlearning process, since a forget dataset and a retain dataset are mutually exclusive, by definition.

In accordance with aspects, a machine unlearning process may include copying an original model, where the copy of the original model is a target model that will be manipulated by the machine unlearning process. A target model including an encoder may be expressed as Se. An original model including an encoder may be expressed as Se. In an exemplary aspect, an original model and a target model may be image-to-image generative models.

In accordance with aspects, a machine unlearning process may receive a datum (which may be expressed as x_{f}) from a forget dataset (which may be expressed as D_{F}) as input to a target model. This may be expressed as

(S_{θ})ΘS_{θ}(x_{f}|θ).

In accordance with aspects, a machine unlearning process may generate a sample drawn from Gaussian noise. This may be expressed as B˜ [symbol] (0, Σ), where [symbol] (0, Σ) represents Gaussian noise and B is the sample drawn from Gaussian noise. The generated sample B may be received as input to the original model. This may be expressed as

S*_{θ}→S*_{θ}(B).

In accordance with aspects, a machine unlearning process may calculate a loss [symbol] based on (S_{θ})→S_{θ}(x_{f}|θ) and S*_{θ}(B). Calculating [symbol] may be expressed as

$${L}_{𝒩} = {‖ {S}_{θ} ( {x}_{f} \vert θ ) - {S}_{θ}^{*} ( B ) ‖}_{2} .$$

In accordance with aspects, a machine unlearning process may receive a datum (which may be expressed as xᵣ) from a retain dataset (which may be expressed as D_{R}) as input to a target model. This may be expressed as

(S*_{θ})→S*_{θ}(xᵣ|θ).

Additionally, a machine learning process may provide the datum (xᵣ) received as input to the target model, as input to the original model, as well. This may be expressed as

S*_{θ}→S*_{θ}(xᵣ).

In accordance with aspects, a machine unlearning process may calculate a loss L_{T} based on (S_{θ})→S_{θ}(xᵣ|θ), and S*_{θ}≥S*_{θ}(xᵣ). Calculating L_{T} may be expressed as

$${L}_{T} = {‖ {S}_{θ} ( {x}_{r} \vert θ ) - {S}_{θ}^{*} ( {x}_{r} ) ‖}_{2} .$$

In accordance with aspects, a machine unlearning process may combine the loss L_{T} and the loss [symbol] with an alpha weighting to generate a weighted combination of the loss L_{T} and the loss [symbol] . A weight, alpha, may be expressed as α. The overall loss function may be the weighted combination of the above two losses with the weight alpha (α) expressed as

$${arg min}_{θ} {E}_{x ∼ {D}_{R} , {x}_{f} ∼ {D}_{F} , B ∼ {𝒩 ( 0 , Σ )}^{\{ {L}_{𝒩} + α {L}_{T} \}}} .$$

This optimization may determine θ such that the expectation over both the forget dataset (D_{F}) and the retain dataset (D_{R}) are minimized.

In accordance with aspects, a total loss accumulation process of a machine unlearning process may perform iterations of the steps, above, and may accumulate a total loss based on a number of iterations of the steps described above. That is, a total loss accumulation process may iterate through the steps of providing the datum from the forget dataset to the target model as input; providing the sample drawn from Gaussian noise to the original model; computing the loss [symbol] ; providing the datum from the retain dataset to the target model; providing the datum from the retain dataset to the original model; computing the loss L_{T}, and combing the loss L_{T} and the loss [symbol] with an alpha weighting to generate a weighted combination of the loss L_{T} and the loss [symbol] . The iterations may be performed a predetermined number of times. For instance, in an exemplary aspect, these steps may be iterated through 128 times. A machine unlearning process may then update the target model S_{θ} with the accumulated loss generated by the iterations of the total loss accumulation process.

In accordance with aspects, a machine unlearning process, including iterations of a total loss accumulation process, may perform iterations using a freshly retrieved datum from the forget dataset and the retain dataset. Iterations of the machine unlearning process may continue, with each iteration retrieving and utilizing a newly retrieved datum from the forget dataset and the retain dataset, until an expectation value is minimized. In an exemplary aspect, the minimal expectation value may not be known. In this case, the machine unlearning process may be iterated a fixed number of times (e.g., 128 times).

For each iteration of a machine unlearning process (where iterations are performed until the expectation value is minimized or for a fixed number of times) the process may provide another datum from the forget dataset to the target model as input; provide a sample drawn from Gaussian noise to the original model; compute a loss [symbol] ; provide another datum from the retain dataset to the target model; providing the same datum from the retain dataset to the original model; computing the loss L_{T}, combine the loss L_{T} and the loss [symbol] with an alpha weighting to generate a weighted combination of the loss L_{T} and the loss [symbol] , and execute a total loss accumulation process, which iterates through the above steps using the new datums from the forget dataset and the retain dataset a predetermined number of times (e.g., 128 times) to accumulate a total loss using the new datums, and then update the target model with the new accumulated total loss for the new datums.

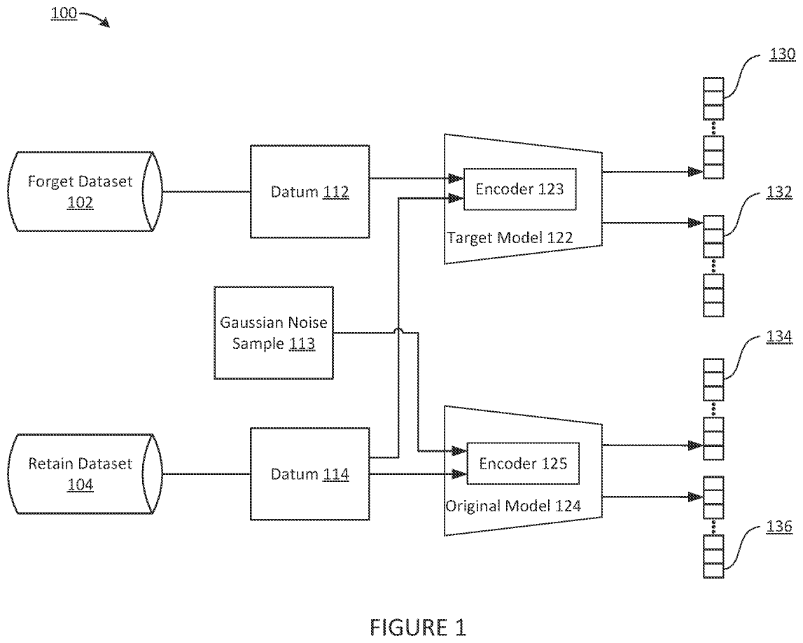

FIG. 1 is a block diagram of a system for providing machine unlearning in generative models, in accordance with aspects. System 100 includes forget dataset 102, retain dataset 104, datum 112, Gaussian noise sample 113, datum 114, target model 122 that includes encoder 123, original model 124 that includes encoder 125, output 130, output 132, output 134 and output 136. Target model 122 and original model 124 may be executed in a modeling engine (not shown) that may be part of an implementing organization's technology infrastructure.

In accordance with aspects, forget dataset 102 may be a dataset of sensitive data. Datum 112 may be a datum (i.e., an image file) from dataset 102. Retain dataset 104 may be a dataset including data that has been filtered to remove sensitive data (i.e., data that has been verified as acceptable data with which to train a ML model). In accordance with aspects, target model 122 and original model 124 may each be an image-to-image generative model. Prior to executing a machine unlearning process, target model 122 may be a copy of original model 124.

In accordance with aspects, datum 112 from dataset 102 may be provided to encoder 123 of target model 122 as input to target model 122. Moreover, Gaussian noise sample 113, which is a sample drawn from Gaussian noise, may be provided as input to encoder 125 of original model 124. Output 130 is output from encoder 123 of target model 122 based on input datum 112. Output 134 is output from encoder 125 of target model 124 based on Gaussian noise sample 113. Output 130 along with output 134 may be used to compute a distance to normal noise (i.e., loss [symbol] , as discussed above).

In accordance with aspects, datum 114 from dataset 104 may be provided to encoder 123 of target model 122 as input to target model 122. Datum 114 may further be provided to encoder 125 of original model 124 as input to original model 124. Output 132 is output from encoder 123 of target model 122 based on input datum 114. Output 136 is output from encoder 125 of original model 124 based on input datum 114. Output 132 and output 136 may be used to compute a distance to original model 124 (i.e., loss L_{T}, as discussed above).

In accordance with aspects, the steps described with respect to the components of FIG. 1 may be iterated a number of times and a total loss may be accumulated based on the number of iterations. A machine unlearning process may then update the target model 122 with the generated accumulated loss. Moreover, once an accumulated loss is secured and target model 122 is updated with the accumulated loss, the process may begin again using a new datum 112 from dataset 102 and a new datum 114 from dataset 104. The process may be iterated through several new datums from each dataset, and the process may minimize an expectation value. Because a minimal expectation value may not be known, the process may iterate a fixed number of times.

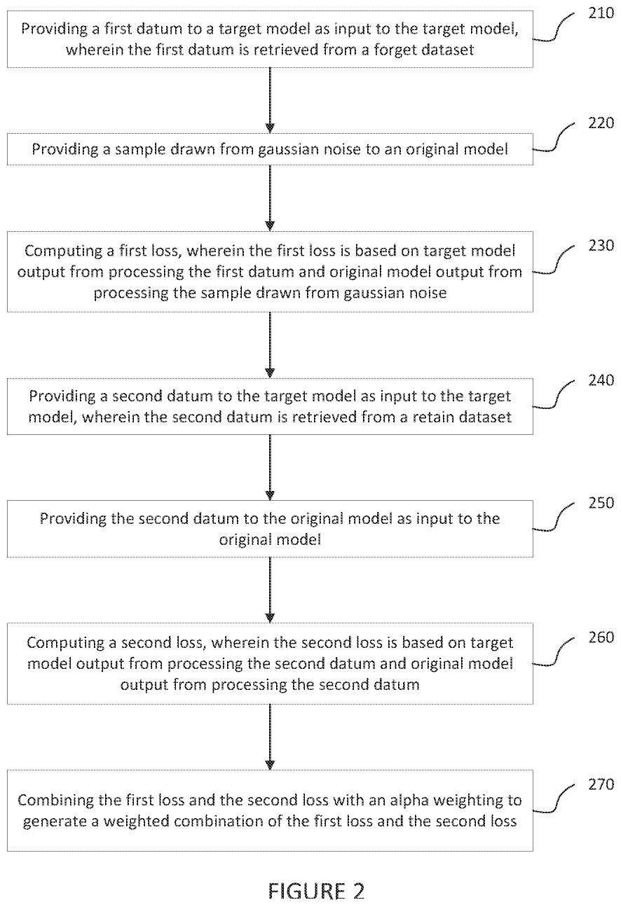

FIG. 2 is a logical flow of a machine unlearning process, in accordance with aspects.

Step 210 includes providing a first datum to a target model as input to the target model, wherein the first datum is retrieved from a forget dataset.

Step 220 includes providing a sample drawn from Gaussian noise to an original model.

Step 230 includes computing a first loss, wherein the first loss is based on target model output from processing the first datum and original model output from processing the sample drawn from Gaussian noise.

Step 240 includes providing a second datum to the target model as input to the target model, wherein the second datum is retrieved from a retain dataset.

Step 250 includes providing the second datum to the original model as input to the original model.

Step 260 includes computing a second loss, wherein the second loss is based on target model output from processing the second datum and original model output from processing the second datum.

Step 270 includes combining the first loss and the second loss with an alpha weighting to generate a weighted combination of the first loss and the second loss.

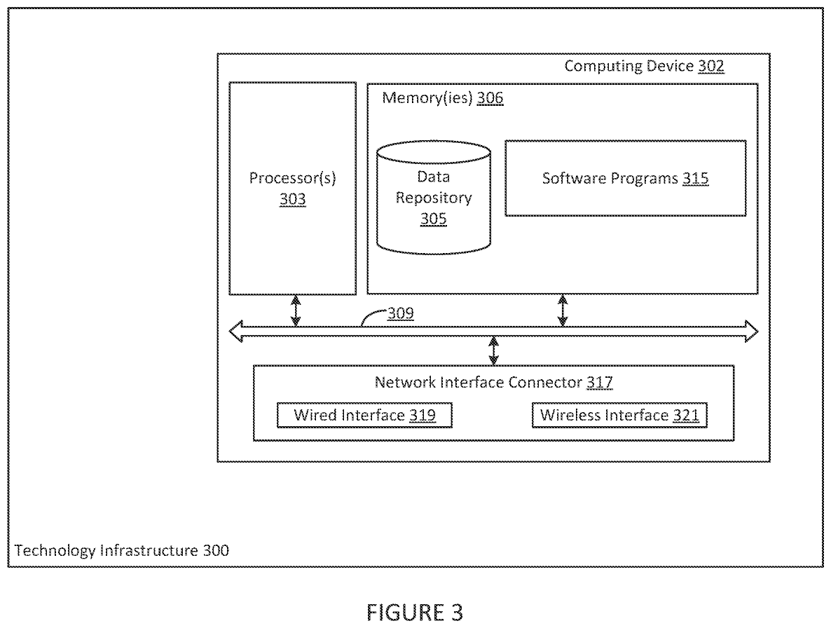

FIG. 3 is a block diagram of a technology infrastructure and computing device for implementing certain aspects of the present disclosure, in accordance with aspects. FIG. 3 includes technology infrastructure 300. Technology infrastructure 300 represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with aspects, system components such as a machine learning model, a modeling engine, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services, modules, engines, etc., that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
executing initial steps of a machine unlearning process, wherein the initial steps include:
providing a first datum to a target model as input to the target model, wherein the first datum is retrieved from a forget dataset;
providing a sample drawn from Gaussian noise to an original model;
computing a first loss, wherein the first loss is based on target model output from processing the first datum and original model output from processing the sample drawn from Gaussian noise;
providing a second datum to the target model as input to the target model, wherein the second datum is retrieved from a retain dataset;
providing the second datum to the original model as input to the original model;
computing a second loss, wherein the second loss is based on target model output from processing the second datum and original model output from processing the second datum; and
combining the first loss and the second loss with an alpha weighting to generate a weighted combination of the first loss and the second loss.

2. The method of claim 1, comprising:
executing a total loss accumulation process, wherein the total loss accumulation process includes a plurality of iterations of the initial steps of the machine unlearning process.

3. The method of claim 2, wherein the total loss accumulation process includes accumulating a total loss based on the plurality of iterations of the initial steps of the machine unlearning process.

4. The method of claim 3, wherein the initial steps of the machine unlearning process include:
updating the target model based on the total loss, wherein executing the total loss accumulation process and updating the target model based on the total loss are secondary steps of the machine unlearning process, and wherein a complete iteration of the machine unlearning process includes executing the initial steps of the machine unlearning process and the secondary steps of the machine unlearning process.

5. The method of claim 4, comprising:
executing a plurality of complete iterations of the machine unlearning process, wherein for each complete iteration of the plurality of complete iterations of the machine unlearning process, a new first datum is provided as input to the target model and a new second datum is provided as input to the target model and to the original model.

6. The method of claim 5, wherein executing the plurality of complete iterations of the machine unlearning process minimizes an expectation value.

7. The method of claim 6, wherein the plurality of complete iterations of the machine unlearning process is a fixed number of iterations.

8. A system comprising at least one computer including a processor and a memory, wherein the at least one computer is configured to:
execute initial steps of a machine unlearning process, wherein the initial steps configure the at least one computer to:
provide a first datum to a target model as input to the target model, wherein the first datum is retrieved from a forget dataset;
provide a sample drawn from Gaussian noise to an original model;
compute a first loss, wherein the first loss is based on target model output from processing the first datum and original model output from processing the sample drawn from Gaussian noise;
provide a second datum to the target model as input to the target model, wherein the second datum is retrieved from a retain dataset;
provide the second datum to the original model as input to the original model;
compute a second loss, wherein the second loss is based on target model output from processing the second datum and original model output from processing the second datum; and
combine the first loss and the second loss with an alpha weighting to generate a weighted combination of the first loss and the second loss.

9. The system of claim 8, the at least one computer is configured to:
execute a total loss accumulation process, wherein the total loss accumulation process includes a plurality of iterations of the initial steps of the machine unlearning process.

10. The system of claim 9, wherein the total loss accumulation process includes accumulating a total loss based on the plurality of iterations of the initial steps of the machine unlearning process.

11. The system of claim 10, wherein the initial steps of the machine unlearning process include:
updating the target model based on the total loss, wherein executing the total loss accumulation process and updating the target model based on the total loss are secondary steps of the machine unlearning process, and wherein a complete iteration of the machine unlearning process includes executing the initial steps of the machine unlearning process and the secondary steps of the machine unlearning process.

12. The system of claim 11, the at least one computer is configured to:
execute a plurality of complete iterations of the machine unlearning process, wherein for each complete iteration of the plurality of complete iterations of the machine unlearning process, a new first datum is provided as input to the target model and a new second datum is provided as input to the target model and to the original model.

13. The system of claim 12, wherein execution of the plurality of complete iterations of the machine unlearning process minimizes an expectation value.

14. The system of claim 13, wherein the plurality of complete iterations of the machine unlearning process is a fixed number of iterations.

15. A non-transitory computer readable storage medium, including instructions stored thereon, which instructions, when read and executed by one or more computer processors, cause the one or more computer processors to perform steps comprising:
executing initial steps of a machine unlearning process, wherein the initial steps include:
providing a first datum to a target model as input to the target model, wherein the first datum is retrieved from a forget dataset;
providing a sample drawn from Gaussian noise to an original model;
computing a first loss, wherein the first loss is based on target model output from processing the first datum and original model output from processing the sample drawn from Gaussian noise;
providing a second datum to the target model as input to the target model, wherein the second datum is retrieved from a retain dataset;
providing the second datum to the original model as input to the original model;
computing a second loss, wherein the second loss is based on target model output from processing the second datum and original model output from processing the second datum; and
combining the first loss and the second loss with an alpha weighting to generate a weighted combination of the first loss and the second loss.

16. The non-transitory computer readable storage medium of claim 15, comprising:
executing a total loss accumulation process, wherein the total loss accumulation process includes a plurality of iterations of the initial steps of the machine unlearning process.

17. The non-transitory computer readable storage medium of claim 16,
wherein the total loss accumulation process includes accumulating a total loss based on the plurality of iterations of the initial steps of the machine unlearning process.

18. The non-transitory computer readable storage medium of claim 17, wherein the initial steps of the machine unlearning process include:
updating the target model based on the total loss, wherein executing the total loss accumulation process and updating the target model based on the total loss are secondary steps of the machine unlearning process, and wherein a complete iteration of the machine unlearning process includes executing the initial steps of the machine unlearning process and the secondary steps of the machine unlearning process.

19. The non-transitory computer readable storage medium of claim 18, comprising:
executing a plurality of complete iterations of the machine unlearning process, wherein for each complete iteration of the plurality of complete iterations of the machine unlearning process, a new first datum is provided as input to the target model and a new second datum is provided as input to the target model and to the original model.

20. The non-transitory computer readable storage medium of claim 19, wherein executing the plurality of complete iterations of the machine unlearning process minimizes an expectation value.
